(19) United States
(12) Patent Application Publication
(10) Pub. No.: US 2006/0075898 A1
(43) Pub. Date: Apr. 13, 2006

(54) Fan having a spray unit for use in a wet type air cleaner

(75) Inventor: Woong Kim, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/246,064

(22) Filed: Oct. 11, 2005

(30) Foreign Application Priority Data
Oct. 11, 2004 (KR) 10-2004-0081069

(51) Int. Cl. B01D 47/00

(52) U.S. Cl. 96/282

(57) ABSTRACT

A fan for use in a wet type air cleaner serves to suction indoor air through an air suction inlet while spraying wash water toward the indoor air, thus allowing dusts or harmful substances in the air to be adsorbed by the wash water. The fan includes a main body disposed in an air circulation passage of the air cleaner and being rotated by a motor, a plurality of blades, installed on an outer peripheral surface of the fan main body, for generating a suctioning force for the intake of air, and a spray unit for dispersing wash water in a circumferential direction of the fan main body, thus allowing the wash water to contact the air and adsorb harmful substances from the air.

### FIELD OF THE INVENTION

The present invention relates to a fan for use in a wet type air cleaner; and, more particularly, to a multifunctional fan for use in a wet type air cleaner having a spray unit incorporated therein capable of dispersing wash water in an air circulation passage while serving to circulate indoor air the an air circulation passage.

### BACKGROUND OF THE INVENTION

In general, a wet type air cleaner is an apparatus for maintaining indoor air clean and pleasant by washing away dusts or harmful substances from the indoor air by way of spraying wash water into a sealed space in the wet type air cleaner and allowing the indoor air to pass through the space.

One example of such wet type air cleaners is disclosed in Japanese Laid Open No. 2000-334240, entitled “WET TYPE AIR CLEANER”, which is filed on May 31, 1999.

The wet type air cleaner includes an air circulation passage through which air is introduced into the inside of the air cleaner and then is outputted to the outside after being purified. A reservoir having liquid to be sprayed therein is formed in a part of the air circulation passage. The air cleaner further includes a blower unit for allowing the air to be circulated through the air circulation passage and a spray unit for spraying the liquid into a sealed space in the reservoir.

The blower unit includes a fan for suctioning the air into the sealed space and a motor for driving the fan. The spray unit includes a pump for pumping up the liquid from the reservoir and a nozzle for spraying the liquid into the sealed space.

Further, the air supplied into the air circulation passage is typically made to flow downward after being introduced into the reservoir from upside, whereas the liquid is sprayed upward from downside. Therefore, the air introduced into the air circulation passage is brought into contact with fine liquid particles sprayed by the nozzle, thereby allowing harmful substances in the air to be adsorbed by the liquid.

In the conventional wet type air cleaner as described above, however, the blower unit for circulating the indoor air and the spray unit for spraying the liquid are installed individually. Therefore, the number of components of the air conditioner cannot be reduced, which is regarded as a limiting factor in reducing the price of the air cleaner.

Moreover, since the fan, the motor for driving the fan and the pump for spraying the liquid through the nozzle are all operated simultaneously, the noise generated as a result of operating the air cleaner cannot be reduced below a certain level.

Besides, since the air discharged from the conventional wet type air cleaner always contains a certain degree of moisture, the use of the conventional wet type air cleaner is not preferred in summer season featuring a high percentage of humidity, though its use is useful in other seasons in which the humidity of air is low.

### SUMMARY OF THE INVENTION

It is, therefore, an object of the present invention to provide a fan for use in a wet type air cleaner having a spray unit incorporated therein capable of dispersing wash water in the air circulation passage while circulating indoor air in the air circulation passage, thereby allowing harmful substances in the indoor air to be adsorbed by the wash water.

It is another object of the present invention to provide a fan for use in a wet type air cleaner having a spray unit for dispersing wash water in a circumferential direction of the fan to maximize a contact area between the wash water and indoor air being circulated, thus improving the efficiency of air purification.

It is further another object of the present invention to provide a wet type air cleaner employing a fan provided with a spray unit therein as described above.

In accordance with a preferred embodiment of the present invention, there is provided a fan for use in a wet type air cleaner includes: a fan main body disposed in an air circulation passage of the air cleaner and being rotated by a motor; a plurality of blades, installed on an outer peripheral surface of the fan main body, for generating a suctioning force for the intake of air; and a spray unit for dispersing wash water in a circumferential direction of the fan main body, thus allowing the wash water to contact the air and adsorb harmful substances from the air.

In accordance with another preferred embodiment of the present invention, there is provided a wet type air cleaner, which includes: a casing provided with an air suction inlet and air outlets through which indoor air is circulated; a fan, disposed in an air circulation passage within the casing, for suctioning the indoor air through the air suction inlet while spraying wash water having therein toward the indoor air, thus allowing dusts or harmful substances in the air to be adsorbed by the wash water; and a water reservoir for providing the wash water to the fan through the air suction inlet.

### BRIEF DESCRIPTION OF THE DRAWINGS

The above and other objects and features of the present invention will become apparent from the following description of preferred embodiments given in conjunction with the accompanying drawings, in which:

FIG. 1 shows a schematic view of a wet type air cleaner in accordance with the present invention;

FIG. 2 is a perspective view of a multifunctional fan for use in a wet type air cleaner shown in FIG. 1; and

FIG. 3 illustrates a cross sectional view of the multifunctional fan shown in FIG. 2.

### DETAILED DESCRIPTION OF THE PREFERRED EMBODIMENTS

Hereinafter, a multifunctional fan for use in a wet type air cleaner in accordance with a preferred embodiment of the present invention will be described in detail with reference to the accompanying drawings.

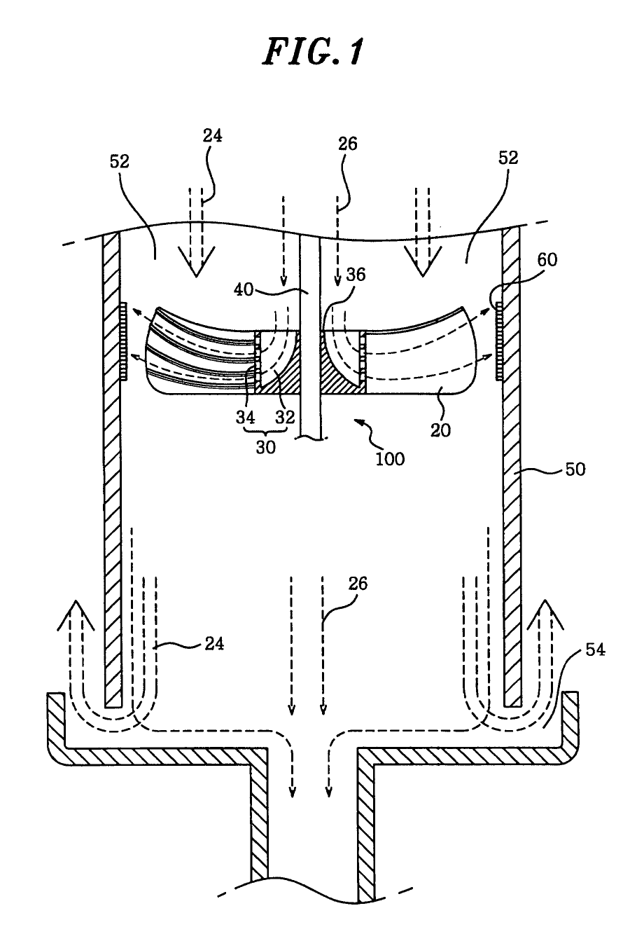

Referring to FIG. 1, there is illustrated a multifunctional fan for use in a wet type air cleaner in accordance with the present invention.

As shown in FIG. 1, the wet type air cleaner includes a casing 50 provided with an air suction inlet 52 and air outlets 54 through which indoor air 24 is circulated; a water reservoir (not shown) installed at an upper portion of the casing 50 to provide wash water 26 therein through the air suction inlet 52; and a multifunctional fan 100 is disposed in an air circulation passage of the air cleaner. The multifunctional fan 100 serves to suction the indoor air through the air suction inlet 52 while spraying the wash water 26 falling down from the water reservoir toward the indoor air, thus allowing dusts or harmful substances in the indoor air 24 to be adsorbed by the wash water 26.

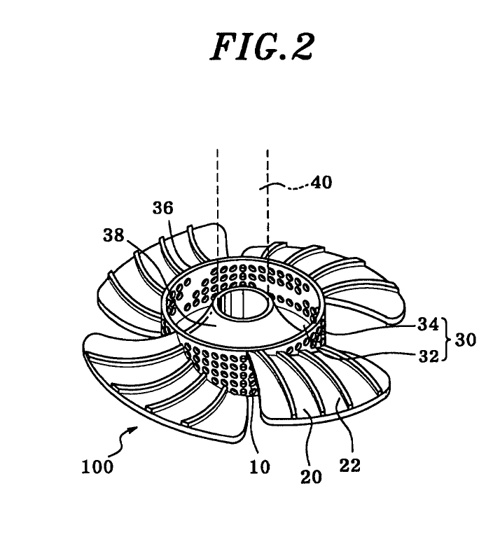

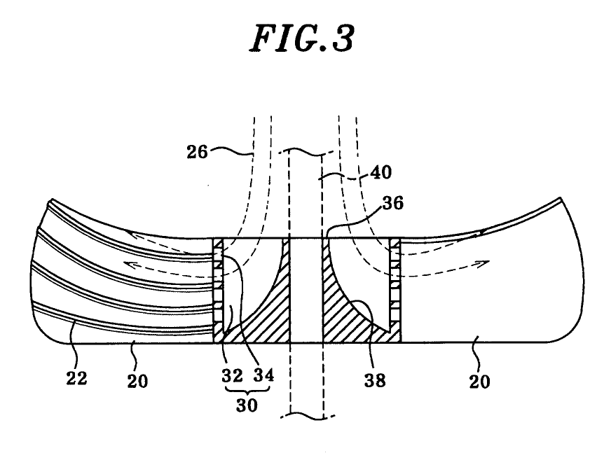

FIGS. 2 and 3 show a detailed configuration of the multifunctional fan illustrated in FIG. 1.

The multifunctional fan 100 includes a fan main body 10 fixedly installed at a rotation shaft 40 to be rotated by a motor (not shown); a plurality of blades 20 formed at the outer peripheral surface of the fan main body 10 to rotate along with the fan main body 10 so as to suction the indoor air 24 through the air suction inlet 52; and a spray unit 30 installed at the fan main body 10 to spray the wash water 26 into the air circulation passage.

In accordance with the present invention, each blade 20 is provided with a plurality of guides 22, wherein the guides 22 are elongated in a radial direction on the top surface of each blade 20. The presence of the guides 22 allows the wash water 26 falling onto the top surfaces of the blades 20 to be dispersed in a circumferential direction of the fan main body 10. That is, the guides 22 are formed in curved shapes to be conformable to the shapes of the blades 20, thus facilitating the dispersion of the wash water 26.

Further, the spray unit 30 includes a water storage tub 32 concavely formed downward from the top surface of the fan main body 10, for storing therein the wash water 26 falling from the reservoir; and a number of water jetting holes 34 provided on the peripheral surface of the water storage tub 22, for jetting the wash water 26 stored in the water storage tub 32 in the circumferential direction of the fan main body 10 by a centrifugal force generated in the fan main body 10.

At its central portion, the water storage tub 32 has a fixing portion 36 into which the rotation shaft 40 is to be inserted, and the fixing portion 36 is provided with an inclined surface 38 whose height decreases from the center toward the periphery thereof. Thus, due to the presence of the inclined surface 38, the wash water 26 falling into the central portion of the fan main body 10 is moved toward the peripheral portion of the water storage tub 32 to be dispersed in the circumferential direction of the fan main body 10.

An operation of the multifunctional fan with the above-described configuration will be described as follows.

First, if a user starts the wet type air conditioner, the motor is driven to rotate the multifunctional fan 100, so that the indoor air 24 is suctioned into the air cleaner through the air suction inlet 52.

As illustrated in FIG. 1, the indoor air 24 is circulated by being introduced into the inside of the air cleaner and discharged into a room again through the air outlets 54 after passing through the multifunctional fan 100. At this time, the wash water 26 supplied onto the top surface of the multifunctional fan 100 is collected in the water storage tub 32 formed in the fan main body 10 and then is dispersed in the circumferential direction of the fan main body 10 through the water jetting holes 34 due to the centrifugal force of the fan main body 10, thereby to spray fine water particles.

Further, the wash water 26 falling onto the top surfaces of the blades 20 is also dispersed in the circumferential direction along the guides 22 provided on the blades 20. Therefore, the effect of dispersing the wash water 26 can be maximized, so that the contact area between the wash water 26 and the indoor air 24 can also be maximized. Moreover, by a strong collision of the wash water with the inner wall of the casing 50, generation of negative ions may be prompted.

Here, given that a frictional force of the air contacting the blades 20 is relatively great, the supply of the wash water to the blades 20 would maximize the scrubbing effect by the friction between the water and the air, thereby improving the efficiency of adsorbing foreign substances.

Furthermore, by increasing or decreasing the number of rotation of the motor, the contact area between the water and the air by the blades 20 can be controlled. Specifically, since the contact area between the water and the air is in proportion to the area of the blades 20 multiplied by the rotation number of the motor, the contact area between the water and the air can be increased by increasing the rotation number of the motor.

The wash water dispersed as described above adsorbs harmful substances from the indoor air while the indoor air passes through the multifunctional fan 100, and generates negative ions by colliding with the inner wall of the air cleaner. Therefore, supply of pleasant air into the room is possible.

Moreover, as shown in FIG. 1, by installing a wire net 60 on the inner wall of the casing 50 where the multifunctional fan 100 is installed, the generation of the negative ions is facilitated when the wash water, i.e., the fine water particle, collides with the wire net 60. Here, besides the wire net 60, any known means to increase the generation of the negative ions can be employed.

In addition, by controlling the rotational speed of the motor for rotating the fan main body 10, the degree of dispersion of the wash water from the multifunctional fan 100 can be readily controlled. If the rotational speed of the motor is great, the amount of the dispersed wash water is also great, so the moisture contained in the indoor air discharged form the air cleaner increases. On the other hand, if the rotational speed of the motor is reduced below a certain level, the amount of the dispersion of the wash water is reduced as well, so that the moisture contained in the indoor air drawn from the air cleaner can be reduced.

Therefore, by controlling the rotational speed of the motor, it is possible to operate the air conditioner appropriately depending on the humidity of the air in the room to be adequate for all seasons including summer or a rainy season with high humidity, and spring, autumn and winter with low humidity.

In accordance with the present invention as described above, the spray unit including the water storage tub and the water jetting holes is installed at the fan for circulating the indoor air. Accordingly, the fan serves as a multifunctional fan for circulating the indoor air while spraying the wash water to the air. Therefore, a nozzle for spraying the wash water is not necessary, so the number of components of the wet type air cleaner can be reduced.

Moreover, by using the multifunctional fan for use in the wet type air cleaner in accordance with the present invention, the structure of the air cleaner becomes simpler, and the fan for circulating the indoor air and a pump for supplying the wash water can be operated by a single motor. Therefore, the manufacturing costs of the air cleaner can be lowered, and the size of the air cleaner can also be reduced.

Further, since the generation of negative ions is facilitated by the wash water which is made to collide with the inner wall of the air cleaner by the spray unit of the multifunctional fan, more peasant indoor environment can be obtained.

Besides, by adjusting the rotational speed of the motor, the humidity of the indoor air discharged from the air cleaner can be simply controlled. Therefore, the air purifying operation and humidifying operation of the air cleaner can be controlled to be adequate for all seasons.

While the invention has been shown and described with respect to the preferred embodiments, it will be understood by those skilled in the art that various changes and modifications may be made without departing from the scope of the invention as defined in the following claims.

What is claimed is:

1. A fan for use in a wet type air cleaner comprising:
a fan main body disposed in an air circulation passage of the air cleaner and being rotated by a motor;
a plurality of blades, installed on an outer peripheral surface of the fan main body, for generating a suctioning force for the intake of air; and
a spray unit for dispersing wash water in a circumferential direction of the fan main body, thus allowing the wash water to contact the air and adsorb harmful substances from the air.

2. The fan of claim 1, wherein each blade is provided on a top surface thereof with a multiplicity of guides, each guide being elongated from the fan main body in the circumferential direction thereof, so that the guide serves to allow the wash water falling onto the top surface of the blade to be dispersed in the circumferential direction of the fan main body.

3. The fan of claim 1, wherein the spray unit includes:
a water storage tub concavely formed downward from a top surface of the fan main body to store therein the wash water; and
a number of water jetting holes provided on a peripheral surface of the water storage tub to jet the wash water stored in the water storage tub in the circumferential direction of the fan main body by a centrifugal force generated in the fan main body.

4. The fan of claim 1, wherein the water storage tub includes a fixing portion into which the rotation shaft of the motor is to be inserted, wherein the fixing portion is installed at a central portion of the water storage tub and is provided with an inclined surface whose height is configured to decrease from a center toward a periphery thereof, to thereby allow the wash water falling into a central portion of the fan main body to be moved toward a peripheral portion of the water storage tub to be dispersed in the circumferential direction of the fan main body.

5. A wet type air cleaner comprising:
a casing provided with an air suction inlet and air outlets through which indoor air is circulated;
a fan, disposed in an air circulation passage within the casing, for suctioning the indoor air through the air suction inlet while spraying wash water having therein toward the indoor air, thus allowing dusts or harmful substances in the air to be adsorbed by the wash water; and
a water reservoir for providing the wash water to the fan through the air suction inlet.

6. The wet type air cleaner of claim 5, wherein the fan includes:
a fan main body disposed in an air circulation passage of the air cleaner and being rotated by a motor;
a plurality of blades, installed on an outer peripheral surface of the fan main body, for generating a suctioning force for the intake of air; and
a spray unit for dispersing the wash water in a circumferential direction of the fan main body, thus allowing the wash water to contact the air and adsorb harmful substances from the air.

7. The wet type air cleaner of claim 6, wherein each blade is provided on a top surface thereof with a multiplicity of guides, each guide being elongated from the fan main body in the circumferential direction thereof, so that the guide serves to allow the wash water free falling onto the top surface of the blade to be dispersed in the circumferential direction of the fan main body.

8. The wet type air cleaner of claim 6, wherein the spray unit includes:
a water storage tub, concavely formed downward from a top surface of the fan main body, for storing therein the wash water; and
a number of water jetting holes, provided on a peripheral surface of the water storage tub, for jetting the wash water stored in the water storage tub in the circumferential direction of the fan main body by a centrifugal force generated in the fan main body.

9. The wet type air cleaner of claim 5, further comprising means for controlling the rotational speed of the fan, to thereby control the degree of dispersion of the wash water from the multifunctional fan.
